(19) United States
(12) Patent Application Publication
(10) Pub. No.: US 2010/0245721 A1
(43) Pub. Date: Sep. 30, 2010

(54) LIQUID CRYSTAL ANTI-FREEZE METHOD AND LIQUID CRYSTAL MODULE USING THE SAME

(75) Inventors: Ching-Hui Chang, Banqiao City (TW); Ching-Feng Hsieh, Taipei City (TW); Ko-Hsien Lee, Dayuan Township (TW)

Correspondence Address: SCHMEISER, OLSEN & WATTS, 22 CENTURY HILL DRIVE, SUITE 302, LATHAM, NY, 12110, US

(73) Assignee: ASKEY COMPUTER CORP., TAIPEI (TW)

(21) Appl. No.: 12/564,106

(22) Filed: Sep. 22, 2009

(30) Foreign Application Priority Data
Mar. 25, 2009 (TW) 98109599

(51) Int. Cl. G02F 1/133; G02F 1/1333

(52) U.S. Cl. 349/72; 349/161

(57) ABSTRACT

A liquid crystal module comprises at least a liquid crystal panel with a display side and a liquid crystal side corresponding to each other, wherein at least one portion of the liquid crystal side is a heating portion, such that the heating portion can be driven to heat the liquid crystal side when the temperature of the environmental is under a liquid crystal working temperature. In addition, a liquid crystal anti-freeze method for the liquid crystal module is disclosed.

### CROSS-REFERENCE TO RELATED APPLICATIONS

This non-provisional application claims priority under 35 U.S.C. §119(a) on Patent Application No(s). 098109599 filed in Taiwan, R.O.C. on 25 Mar. 2009, the entire contents of which are hereby incorporated by reference.

### FIELD OF THE INVENTION

The present invention relates to a liquid crystal display technology, and more particularly to a liquid crystal anti-freeze method and a liquid crystal module using the method.

### BACKGROUND OF THE INVENTION

Liquid crystal display technology is applied extensively in present electronic products such as computers, televisions, global positioning system (GPS), mobile phones, personal digital assistants (PDA), and monitors, etc. In general, the aforementioned electronic products using the liquid crystal display technology comprise a liquid crystal module (LCM), and the liquid crystal module includes a liquid crystal panel, and related technologies are disclosed in R.O.C. Pat. Nos. I276482, I1279131, I250319 and I230824.

As to an application in an environment of a lower temperature such as an application at a temperature below −20°, liquid crystals in a liquid crystal module of an electronic product having a liquid crystal working temperature ranging from 0° to 60° will be frozen at such a low temperature. As a result, the electronic product cannot be operated normally, and the electronic product operated at a too-low temperature or used in the low-temperature environment is unable to drive and operate the liquid crystal module, and a blank frequency or other errors will occur during a display. Manufacturers generally adopt special materials and manufacturing processes to assure the normal operation of the liquid crystal module.

Traditionally, an anti-freezing agent or another additive for suppressing the freezing of liquid crystals is added into the liquid crystals to maintain the normal operation of the liquid crystals. However, the liquid crystal modules added with the anti-freezing agent must be custom-made according to the required size. If the liquid crystal modules are not purchased in a large quantity, liquid crystal module suppliers are unwilling to supply such custom-made liquid crystal modules. In other words, manufacturers may have difficulties to purchase the liquid crystal modules added with the anti-freezing agent, or manufacturers have to pay a relatively high price for the liquid crystal modules. For products with an economic scale in the small to mid sized market, the aforementioned factors undoubtedly limit the development of the products. Furthermore, the effect of improving the display of liquid crystals by adding anti-freezing agent into the liquid crystals has not been proven or supported by official reports yet.

Obviously, manufacturers in the related industry have an urgent need to overcome the aforementioned shortcomings of the prior art by developing a novel liquid crystal anti-freeze technology, providing the flexibility of purchasing the liquid crystal modules, and lowering the cost of the liquid crystal modules.

### SUMMARY OF THE INVENTION

Therefore, it is a primary objective of the present invention to overcome the shortcomings of the prior art by providing a liquid crystal anti-freeze method and a liquid crystal module using the method to assure the normal operation of the liquid crystals in a low-temperature environment.

Another objective of the present invention is to provide a liquid crystal anti-freeze method and a liquid crystal module using the method for reducing electromagnetic interference (EMI).

To achieve the foregoing objectives and other objectives, the present invention provides a liquid crystal anti-freeze method and a liquid crystal module using the method, wherein the liquid crystal module includes a liquid crystal panel, and the liquid crystal panel includes a display side and a liquid crystal side opposite to the display side, characterized in that at least a portion of the liquid crystal side is a heating portion. The liquid crystal anti-freeze method of the present invention is applied to different liquid crystal modules having the aforementioned basic structure, and the liquid crystal anti-freeze method comprises the steps of: forming a heating portion on at least one portion of the liquid crystal side; defining a liquid crystal working temperature range of the liquid crystal module; detecting a temperature value of the liquid crystal module; and starting the heating portion to heat the liquid crystal side, if the temperature value exceeds the liquid crystal working temperature range.

In the liquid crystal module, the heating portion includes at least one heating plate. The heating portion can be an electrothermal heating plate, wherein the heating portion includes a base layer, a top layer, and an electro-conductive circuit installed between the base layer and the top layer. In an embodiment, the heating portion has a size equal to the liquid crystal panel, and in another embodiment, the heating portion has a size smaller than the liquid crystal panel. The heating portion is a heating plate made of a magnetic material, wherein the magnetic material is a material selected from the collection of graphite, nano copper, and carbon.

The liquid crystal module further includes a temperature sensor installed at the liquid crystal panel. The temperature sensor is selectively installed at a surface or in the interior of the liquid crystal panel.

In the aforementioned liquid crystal anti-freeze method, the liquid crystal working temperature ranges from 0° to 60°. In an embodiment, a temperature value at the surface of the liquid crystal panel is detected. Of course, in other embodiments, the temperature value inside the liquid crystal panel or at any other part of the liquid crystal panel is detected.

Compared with the prior art, the present invention can assure the normal operation of liquid crystals in a low-temperature environment by the aforementioned heating technique without the need of purchasing a large quantity of anti-freezing agents or additives at a time, so as to overcome the limitation, cost and inventory issues of the prior art, and the invention is cost-effectively. In the meantime, the heating portion of the present invention can be used flexibly to prevent the liquid crystals from being frozen, and the heating portion also provides an electromagnetic interference shielding effect to reduce electromagnetic interference.

### BRIEF DESCRIPTION OF THE DRAWINGS

FIG. 1 is an exploded view of a liquid crystal module in accordance with a first preferred embodiment of the present invention;

FIG. 2 is a partial cross-sectional view of FIG. 1;

FIG. 3 is a flow chart of a liquid crystal anti-freeze method in accordance with a first preferred embodiment of the present invention;

FIG. 4 is a block diagram of a liquid crystal anti-freeze method in accordance with a first preferred embodiment of the present invention;

FIG. 5 is a partial cross-sectional view of a liquid crystal module in accordance with a second preferred embodiment of the present invention;

FIG. 6 is a flow chart of a liquid crystal anti-freeze method in accordance with a second preferred embodiment of the present invention;

FIG. 7 is a partial cross-sectional view of a liquid crystal module in accordance with a third preferred embodiment of the present invention; and

FIG. 8 is a partial cross-sectional view of a liquid crystal module in accordance with a fourth preferred embodiment of the present invention.

### DESCRIPTION OF THE PREFERRED EMBODIMENT

Other features and advantages of the present invention will become apparent in the following detailed description of the preferred embodiments with reference to the accompanying drawings.

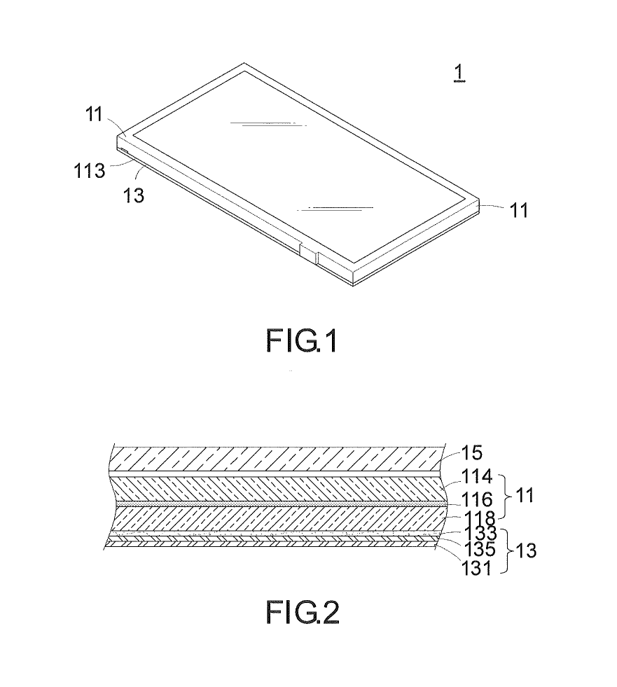

With reference to FIGS. 1 to 4 for a liquid crystal anti-freeze method and a liquid crystal module using the method in accordance with a first preferred embodiment of the present invention, the liquid crystal anti-freeze method comprises the steps of: forming a heating portion on at least one portion of a liquid crystal side of the liquid crystal module; defining a liquid crystal working temperature range of the liquid crystal module; detecting a temperature value of the liquid crystal module, and starting the heating portion to heat the liquid crystal side for maintaining the normal operation of liquid crystals if the temperature value exceeds the liquid crystal working temperature range. The liquid crystal anti-freeze method can be applied to different liquid crystal modules, such as the liquid crystal modules described in the aforementioned preferred embodiments and any other liquid crystal module having liquid crystals. Since the structure and operating principle of the liquid crystal modules are prior arts, they will not be described here.

With reference to FIG. 1, the liquid crystal module 1 comprises a liquid crystal panel 11 and a heating portion 13 installed at the liquid crystal panel 11. The liquid crystal panel 11 includes a display side 111 and a liquid crystal side 113 opposite to the display side 111. The heating portion 13 is disposed on the liquid crystal side 113; in order words, the heating portion 13 is disposed on a backside of the liquid crystal module 1.

With reference to 2 for a liquid crystal module in accordance with a first preferred embodiment of the present invention, the liquid crystal module 1 comprises a liquid crystal panel 11 having a heating portion 13 disposed at the bottom of the liquid crystal panel 11, and a front light unit 15 installed at the top of the liquid crystal panel 11. The liquid crystal panel 11 includes a first substrate 114, a liquid crystal layer 116 disposed on the first substrate 114 and away from a lateral side of the front light unit 15, and a second substrate 118 disposed on the liquid crystal layer 116 and away from a lateral side of the first substrate 114, and the heating portion 13 is used for coupling the second substrate 118. The first substrate 114 and the second substrate 118 can be made of glass.

Persons ordinarily skilled in the art should know that the structure of the liquid crystal module 1 may have other alterations or modifications, and this preferred embodiment is provided for the illustration purpose only, but not for limiting the scope of the present invention. Since the front light unit 15, the liquid crystal layer 116, the first substrate 114, and the second substrate 118 of the liquid crystal module and any other component not shown in the figure are prior arts, they will not be described here again.

The heating portion 13 is an electro-conductive heating plate provided for heating the liquid crystal side 113 when the heating portion 13 is turned on. In this preferred embodiment, the heating portion 13 such as the electrothermal heating plate has a size equal to the size of the liquid crystal panel 11, and the heating portion 13 selectively includes a base layer 131, a top layer 133, and an electro-conductive circuit 135 installed between the base layer 131 and the top layer 133. Of course, in another preferred embodiment, the heating portion 13 can have a size greater than the size of the liquid crystal panel 11, and the structure of the heating portion 13 is not limited to the structure described in this preferred embodiment only. The heating portion 13 can also be a heating plate made of a magnetic material such as graphite, nano copper, carbon or any other equivalent magnetic material, and provided for reducing electromagnetic interference. In addition, the heating portion 13 can be any heating plate that provides good heat dispersion performance, small thickness, and good electromagnetic interference shielding effect. Although the heating portion 13 for providing the anti-freezing effect in accordance with this preferred embodiment is sheet-shaped, but the shape of the heating portion 13 can be changed to other shapes in other preferred embodiments according to the product requirements. The shape of the heating portion 13 is not limited to the shape of this preferred embodiment only, but it can also be tubular, granular, bar-shaped, ring-shaped or any shape applicable for the present invention.

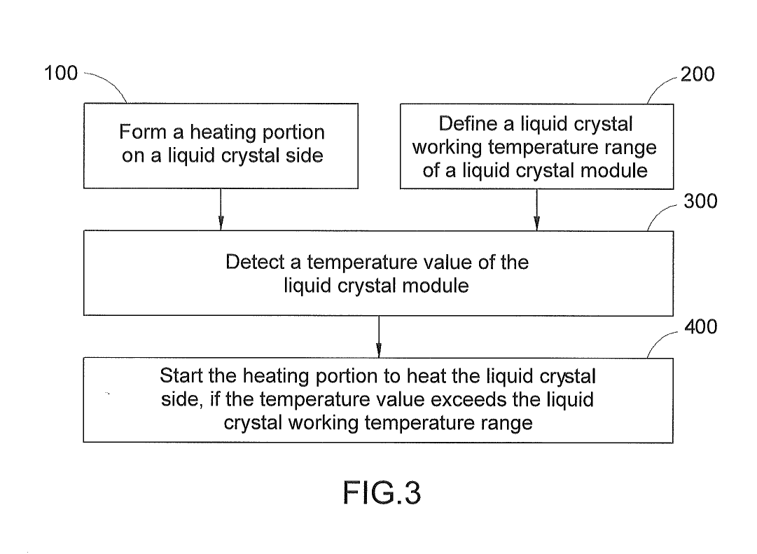

In FIGS. 3 and 1, Steps 100 and 200 are carried out for preventing liquid crystals of the liquid crystal module 1 from being frozen. In Step 100, a heating portion 15 is formed on the liquid crystal side 113. In Step 200, a liquid crystal working temperature range of the liquid crystal module 1 is defined.

In Step 100 as shown in FIG. 1, the heating portion 15 is attached and coupled onto the liquid crystal side 113, or more specifically, the heating portion 15 is attached and coupled onto the second substrate 118 as shown in FIG. 2.

In Step 200, the liquid crystal working temperature generally ranges from 0° to 60°. Of course, the liquid crystal working temperature range is not limited to this range only, but it may be changed to other ranges.

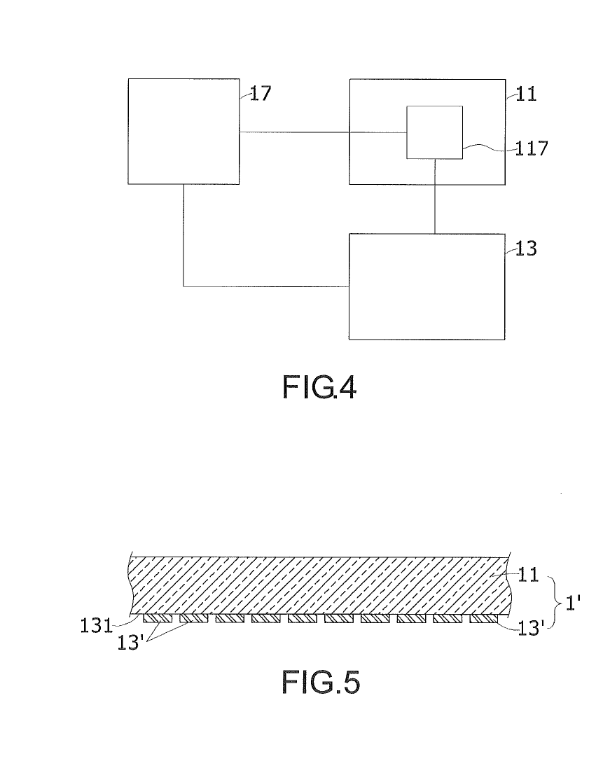

In Step 300, a temperature value of the liquid crystal module 1 is detected. At least one temperature sensor is selectively installed at the liquid crystal panel 11. In this preferred embodiment as shown in FIG. 4, the liquid crystal panel 11 includes a temperature sensor 117 for detecting the temperature value of the liquid crystal module 1, and the temperature sensor 117 can also be installed at a surface and the interior of the liquid crystal module 1 or at any equivalent position such as a circuit board that can detect the temperature value of liquid crystals.

In this preferred embodiment, another temperature sensor 117 is installed for detecting the temperature value of the liquid crystal module 1, but persons ordinarily skilled in the art should know that the temperature sensor 117 can also be installed at any other position of the liquid crystal module 1 or onto an electronic product as well. In other words, the temperature sensor 117 can be a built-in component of the liquid crystal module 1, or a built-in component of the electronic product. Since the temperature sensors of the liquid crystal module 1 and the electronic product are prior art, they will not be described here.

The liquid crystal working temperature range of this preferred embodiment is from 0° to 60°, and thus the working range of the temperature sensor 117 is greater than or equal to the aforementioned liquid crystal working temperature range. In other words, the existing temperature sensor of the electronic product or the liquid crystal module can be used, or when there is a change of the liquid crystal working temperature range, a temperature sensor with the working range corresponding to the liquid crystal working temperature range can be adopted. For example, a temperature sensor with a working temperature range greater than that of this preferred embodiment is used.

In Step 400, the heating portion 13 is turned on to heat the liquid crystal side 113 if the temperature value exceeds the liquid crystal working temperature range. In this preferred embodiment as shown in FIG. 4, the liquid crystal module 1 includes a control unit 17 capable of receiving a signal transmitted from the temperature sensor 117. If the temperature of the liquid crystal is below the liquid crystal working temperature range such as the liquid crystal module 1 operated in an environment of a very low temperature, then the heating portion 13 will be turned on; and if the temperature of the liquid crystals detected by the temperature sensor 117 reaches the liquid crystal working temperature range, a signal will be transmitted to the control unit 17 to stop the heating operation of the heating portion 13. In other words, this preferred embodiment adopts an additional defrosting technique to defrost the liquid crystals in the liquid crystal module 1. The heating portion 13 is an electro-conductive heating plate, so that the generated heat can be dispersed to the liquid crystal side 113 for heating the liquid crystal layer 116 through the second substrate 118 as shown in FIG. 2.

Since the heating portion of this preferred embodiment can be a conventional heating plate, the heating portion can be used in the invention for defrosting the liquid crystals even for products produced in a small quantity.

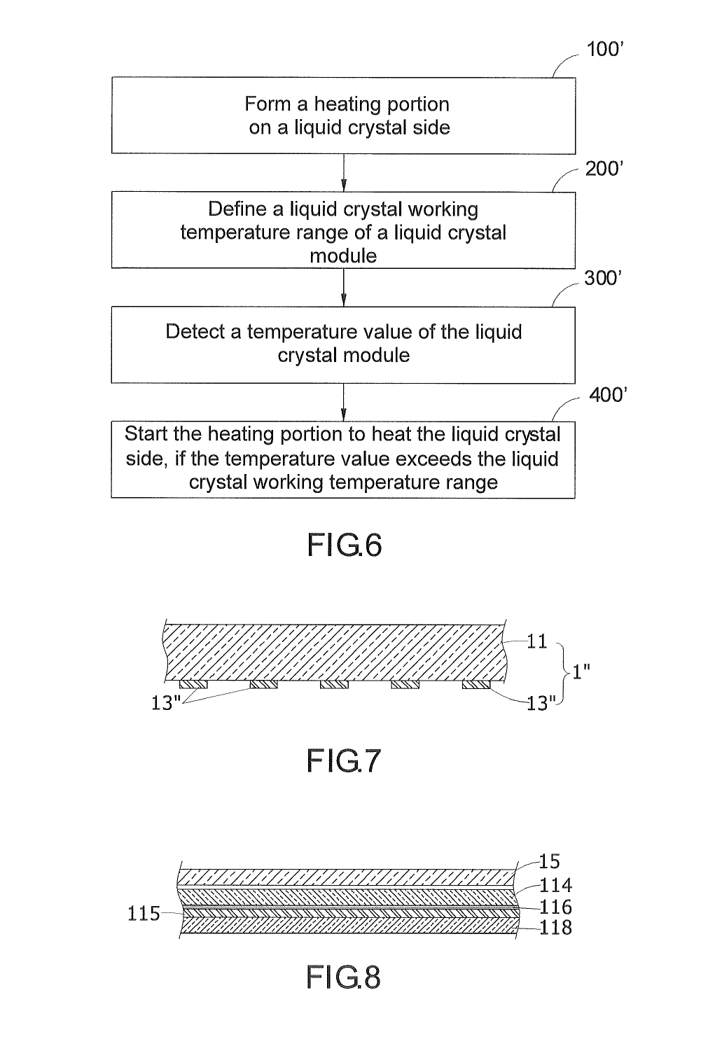

With reference to FIGS. 5 and 6 for a liquid crystal module and a liquid crystal anti-freeze method in accordance with a second preferred embodiment of the present invention, same elements in the first preferred embodiment are represented by respective same numerals in the figures, and the difference of this embodiment from the first preferred embodiment resides on that the heating portion of the second preferred embodiment is a single sheet of heating plate, and the order of the steps in the anti-freeze method of the second preferred embodiment is changed.

In FIG. 5, the liquid crystal module 1′ comprises a liquid crystal panel 11 and a heating portion disposed on at least one portion of the liquid crystal side 113. In this preferred embodiment, the heating portion 13′ is comprised of a plurality of heating plates, and each heating plate has a size smaller than the liquid crystal panel 11, and the heating plates are disposed with a specific interval apart from each other. In other words, the heating portion 13′ has a size smaller than the liquid crystal panel 11. Since the liquid crystals of the liquid crystal side 113 comes with a thermal conductivity, therefore the heat can be conducted uniformly to the adjacent liquid crystal side 113, even though the heating portion 13′ has not covered the whole liquid crystal side 113.

In the preferred embodiment as shown in FIG. 6, Step 100′ is carried out, and the heating portion 13′ is disposed at a portion of the liquid crystal side 113. In Step 200′, a liquid crystal working temperature range of the liquid crystal module 1′ is defined. In Step 300, a temperature value of the liquid crystal module 1 is detected. In Step 400, the heating portion 13′ is turned on to heat the liquid crystal side 113, if the temperature value exceeds the liquid crystal working temperature range.

Although Steps 100 and 200 are carried out simultaneously in the first preferred embodiment, and Step 100′ is carried out first and then Step 200′ is carried out in the second preferred embodiment, the order of other preferred embodiments is not limited to the aforementioned orders only.

With reference to FIG. 7 for a partial cross-sectional view of a liquid crystal module in accordance with a third preferred embodiment of the present invention, same numerals are used for representing respective elements in this preferred embodiment and the aforementioned preferred embodiments for simplicity.

Unlike the second preferred embodiment, the overall area of the heating portion of the third preferred embodiment is smaller than that of the second preferred embodiment.

In FIG. 7, the heating portion 13″ is comprised of a plurality of heating plates, but the interval between two adjacent heating plates of this preferred embodiment is greater than that of the second preferred embodiment. In other words, this preferred embodiment just use less heating plates for transmitting the heat by means of the thermal conductivity of the heating plate and the liquid crystals. In this preferred embodiment, the heating portion 13″ has a size smaller than the liquid crystal panel 11. After the heating portion 13″ is installed onto the liquid crystal panel 11, the heating portion 13″ substantially cover more than half of the area of the liquid crystal panel 11. Of course, in other preferred embodiments, different sizes of the heating portion for covering the required area can be selected according to the material and the thermal conductivity of the heating portion and the response time of the product. Each heating plate in the heating portion can be arranged flexibly. For example, if the liquid crystal module is operated in an environment of 20° and within the liquid crystal working temperature range of 10° for increasing the temperature value of the liquid crystal from zero to 20°, and the response time of the product is 30 seconds, then the electric quantity and the size (or area) of the heating portion can be used for defining the aforementioned time and corresponding current.

With reference to FIG. 8 for a partial cross-sectional view of a liquid crystal module in accordance with a fourth preferred embodiment of the present invention, same elements in this preferred embodiment are represented by respective same numerals in the figures.

In the previous preferred embodiments, the heating portion is attached onto the second substrate, such that the heating portion is situated on the liquid crystal side. In this preferred embodiment, the position of the heating portion is changed and the heating portion is integrally formed with the liquid crystal panel.

In FIG. 8, the liquid crystal layer 116 is disposed on the first substrate 114 and at a position away from a lateral side of the front light unit 15, and the heating portion 115 is installed between the liquid crystal layer 116 and the second substrate 118. The heating portion 115 is integrally formed with the liquid crystal panel. Compared with the structure of the heating portion 13 in accordance with the first preferred embodiment, the base layer 131 of the heating portion 115 adopted in the first preferred embodiment can be omitted and the second substrate 118 is used as the base layer 131 in this preferred embodiment. The second substrate 118 can be made of a silicone layer or any other equivalent film layer or sheet material, but not limited to glass as used in the first preferred embodiment.

In summation of the description above, the present invention has a design of heating the heating portion to maintain a temperature for the normal operation of the liquid crystal module, and the installed position and structure of the heating portion can be changed to meet different product requirements. In other words, the liquid crystal anti-freeze method of the present invention can be applied to different liquid crystal modules, and the variations of the aforementioned preferred embodiments can be adopted. Those skilled in the art should be able to understand the technical characteristics of the present invention. Compared with the prior art, the heating method and heating structure of the present invention can be used flexibly in order to assure the normal operation of the liquid crystals in a low-temperature environment and achieve the effects of lowering the purchasing cost as well as reducing the electromagnetic interference.

While the invention has been described by means of specific embodiments, numerous modifications and variations could be made thereto by those skilled in the art without departing from the scope and spirit of the invention set forth in the claims.

What is claimed is:

1. A liquid crystal module, comprising a liquid crystal panel having a display side and a liquid crystal side opposite to the display side, characterized in that at least a portion of the liquid crystal side is a heating portion.

2. The liquid crystal module of claim 1, wherein the heating portion includes at least one heating plate.

3. The liquid crystal module of claim 2, wherein the heating portion is an electrothermal heating plate.

4. The liquid crystal module of claim 3, wherein the heating portion includes a base layer, a top layer, and an electro-conductive circuit installed between the base layer and the top layer.

5. The liquid crystal module of claim 2, wherein the heating portion has a size greater than or equal to the liquid crystal panel.

6. The liquid crystal module of claim 2, wherein the heating portion has a size smaller than the liquid crystal panel.

7. The liquid crystal module of claim 1, wherein the heating portion is a heating plate made of a magnetic material.

8. The liquid crystal module of claim 7, wherein the magnetic material is a material selected from the collection of graphite, nano copper and carbon.

9. The liquid crystal module of claim 1, further comprising a temperature sensor installed at the liquid crystal panel.

10. The liquid crystal module of claim 9, wherein the temperature sensor is installed at a surface of the liquid crystal panel.

11. The liquid crystal module of claim 9, wherein the temperature sensor is installed in the interior of the liquid crystal panel.

12. A liquid crystal anti-freeze method, applied to a liquid crystal module having at least one liquid crystal panel, and the liquid crystal panel having a display side and a liquid crystal side opposite to the display side, and the liquid crystal anti-freeze method comprising:
forming a heating portion on at least one portion of the liquid crystal side;
defining a liquid crystal working temperature range of the liquid crystal module;
detecting a temperature value of the liquid crystal module; and
starting the heating portion to heat the liquid crystal side, if the temperature value exceeds the liquid crystal working temperature range.

13. The liquid crystal anti-freeze method of claim 12, wherein the liquid crystal working temperature ranges from 0° to 60°.

14. The liquid crystal anti-freeze method of claim 12, wherein the temperature value at a surface of the liquid crystal panel is detected.

15. The liquid crystal anti-freeze method of claim 12, wherein the temperature value at the interior of the liquid crystal panel is detected.

16. The liquid crystal anti-freeze method of claim 12, wherein the heating portion includes at least one heating plate.

17. The liquid crystal anti-freeze method of claim 16, wherein the heating portion is an electrothermal heating plate.

18. The liquid crystal anti-freeze method of claim 12, wherein the heating portion is a heating plate made of a magnetic material.
